(19) United States
(12) Patent Application Publication
(10) Pub. No.: US 2008/0168890 A1
(43) Pub. Date: Jul. 17, 2008

(54) DRUMSTICK WITH VIBRATION LIMITING RING

(76) Inventor: Brian JUDD, Campbell, CA (US)

Correspondence Address: GLENN PATENT GROUP, 3475 EDISON WAY, SUITE L, MENLO PARK, CA, 94025, US

(21) Appl. No.: 12/015,951

(22) Filed: Jan. 17, 2008

Related U.S. Application Data
(60) Provisional application No. 60/880,836, filed on Jan. 17, 2007.

(51) Int. Cl. G10D 13/02

(52) U.S. Cl. 84/422.4

(57) ABSTRACT

A drumstick incorporates a ring or band of elastomer or plastic material that fits into a corresponding groove on the drumstick. The band prevents the loss of energy in the stick to vibration and allow the user to get a more powerful and solid impact on the drumhead. The groove is ideally placed near the butt end of the drumstick. The band may also employ small ribs traversing the inside of the band so that the ribs creates a secure contact area providing a tight fit but allowing the rest of the band to move more freely helping in the dampening effect of the band. This may also be accomplished with a multitude of finger like protrusions on the inside of the band. The ribs or fingers may be ideally angled to allow a flexing that keeps a constant but not rigid contact with the stick.

### CROSS REFERENCE TO RELATED APPLICATIONS

This application claims priority to U.S. provisional patent application Ser. No. 60/880,836, filed Jan. 17, 2007, the entirety of which is incorporated herein by this reference thereto.

### BACKGROUND OF THE INVENTION

1. Technical Field

The invention relates to musical instruments. More particularly, the invention relates to a drumstick having a vibration limiting ring.

2. Description of the Prior Art

One typical application where a user strikes an elongated rigid shaft onto a rigid surface is that of drumsticks. Drummers traditionally use wooden drumsticks, however, although by far not as popular, there are others made of metal and plastic.

Drumsticks are held in a few standard positions, one common position is hold by hand the drumstick about ⅓ of the way from what is referred to as the butt end. The drummer will typically pivot the drumstick at the holding point and strike a drum with the striking end of the drumstick.

It is a well know problem that when the striking end of the drumstick impacts the drum surface there is vibration energy that is transmitted from the point of impact into the shaft of the drumstick and thereby into the users hand, wrist, and tendons, which is known to cause fatigue, tendonitis, what is referred to as drummer's elbow, and other related problems.

Attempts have been made to reduce the vibration transferred to a drum player's hand. Some known techniques drill out a cylindrical hole in the butt end of the drumstick, and fill the volume with a relatively more dense and compliant material than that of the drumstick, e.g. by inserting rubber. Although such approaches do tend to reduce the vibration transferred into the player's hand by reducing the vibration of the drumstick, several very undesirably problems result from this approach. For example, because the butt of the stick is hollowed out, its structural integrity is compromised and it has a much greater tendency to break during use, especially when the player uses the butt end to strike the drum. Another exemplary problem is that players usually do not want to purchase a special kind of drumstick so modified, which are often more costly due to the higher manufacturing cost, or similarly modify their own drumstick. Moreover, many players dislike such conventional approaches as the overall feel of the drumstick is changed, e.g. a new center of mass, which feel is often an important factor in optimal playing performance. Significant retraining by the musician is typically required to adapt to a new drumstick feel.

Other known techniques attempt to isolate the drumstick from the hand by way of a compliant sleeve, or handgrip, on the gripping location of the drumstick. Although such approaches do tend to reduce the vibration transferred into the player's hand by reducing the vibration of the drumstick, they also unfortunately drastically alter the feel of the drumstick to the play, which is very undesirable to most trained musicians. Musicians are typically trained to a certain size of drumstick to achieve a certain sound during play. For example, the addition of a handgrip significantly changes the drumstick's weight distribution and increases the diameter at the holding location of the drumstick and often requires the musicians to retrain themselves to attain the same level of performance, as they normally would have without using the handgrips.

Similar impact vibration problems exist in many other applications, which have an elongated shaft that is held by a person who is striking a hard surface therewith. Hammer applications are one example, where a very similar profile of causality and usage problems exist in the context of the foregoing drumstick application. It is well known that upon striking a hammer on a rigid surface that after the impact there are residual vibrations that transfer into the persons wrist and elbow to cause discomfort and, over time, pain or injury. Some conventional attempts to reduce impact vibration to the user have been mainly focused on the selection of shaft, or handle, material or grip thereof, including shafts made from wood and fiberglass and the molding of rubber handle grips.

In B. Judd, Apparatus for dampening impact vibration in manual tools, U.S. patent application publication no. 20060107818 (filed Nov. 24, 2004), a device is provided for dampening the impact vibration of elongated manual tools that have a handle, such as drumsticks and hammers. The device includes means for dampening the vibration caused when striking tool onto a hard surface, and means for removably joining the dampening means to the end of the tool's handle. Some embodiments further include means for standing off the dampening means from being fully applied onto the end of the tool's handle.

The ability to identify a drumstick by size and type is also a problem for drummers as they need to read the printed size on the stick. This printing often times wears out and is illegible. This is especially a problem when playing on stage which is usually dark.

Hence, it would be desirable for improved techniques of dampening impact vibrations in manual tools. It would be further desirable if such improved approaches were applied to drumsticks, for example to improve the ability of a drummer to identify drumsticks by size and type.

### SUMMARY OF THE INVENTION

Disclosed is a drumstick that incorporates a ring or band of elastomer or plastic material that fits into a corresponding groove on the drumstick. The band prevents the loss of energy in the stick to vibration and allow the user to get a more powerful and solid impact on the drumhead. The groove is ideally placed near the butt end of the drumstick. The preferred embodiment of this groove is approximately 0.25 inches wide and 0.0625 thick. The band may also employ small ribs traversing the inside of the band so that the ribs creates a secure contact area providing a tight fit but allowing the rest of the band to move more freely helping in the dampening effect of the band. This may also be accomplished with a multitude of finger like protrusions on the inside of the band. The ribs or fingers may be ideally angled to allow a flexing that keeps a constant but not rigid contact with the stick. This is important to meter the dampening effect, given that wood is not dimensionally stable and cannot keep tight tolerances.

A further feature of the invention is used to identify the stick size or model by using different colored rings for the different sizes and types. This allows the drummer to have a clear visual identification of his drumstick. This color coding could also be achieved with a painted band around the end of the drumstick although the paint or printing tends to wear off, whereas the colored ring does not change.

### BRIEF DESCRIPTION OF THE DRAWINGS

FIG. 1 is a perspective view showing a drumstick having a dampening band at an end thereof according to the invention;

FIG. 2 is a cross section, perspective view of an end portion of a drumstick showing a dampening band according to the invention;

FIG. 3 is a plan view of a dampening band for a drumstick according to the invention;

FIG. 4 is a side view of a dampening band for a drumstick according to the invention; and

FIG. 5 is a cross section, perspective view of a dampening band for a drumstick according to the invention.

FIG. 6 is a cutaway perspective view of a dampening band 20 for a drumstick 10 according to the invention.

### DETAILED DESCRIPTION OF THE INVENTION

Disclosed is a drumstick that incorporates a ring or band of elastomer, plastic, or other material that fits into a corresponding groove on the drumstick. The band prevents the loss of energy in the stick to vibration and allow the user to get a more powerful and solid impact on the drumhead. The groove is ideally placed near the butt end of the drumstick. The preferred embodiment of this groove is approximately 0.25 inches wide and 0.0625 thick. The band may also employ small ribs traversing the inside of the band so that the ribs creates a secure contact area providing a tight fit but allowing the rest of the band to move more freely helping in the dampening effect of the band. This may also be accomplished with a multitude of finger like protrusions on the inside of the band. The ribs or fingers may be ideally angled to allow a flexing that keeps a constant but not rigid contact with the stick. This is important to meter the dampening effect, given that wood is not dimensionally stable and cannot keep tight tolerances.

A further feature of the invention is used to identify the stick size or model by using different colored rings for the different sizes and types. This allows the drummer to have a clear visual identification of his drumstick. This color coding could also be achieved with a painted band around the end of the drumstick although the paint or printing tends to wear off, whereas the colored ring does not change.

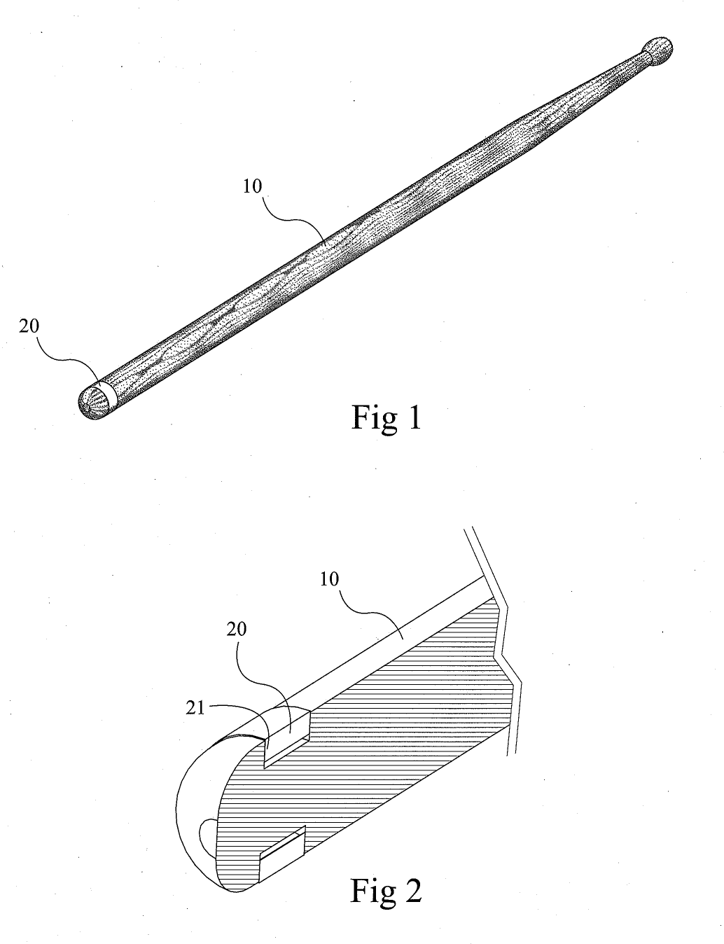

FIG. 1 is a perspective view showing a drumstick 10 having a dampening band 20 at an end thereof according to the invention. The drumstick has an annular groove into which the dampening band is set. This serves both to provide a dampening function without altering the profile of the drumstick, and to retain the dampening band securely to the drumstick. Other embodiments of the invention may provide a ring or band that is fitted near a butt end of a drumstick on the surface thereof, e.g. not within an annular groove. Such application is intended to provide a dampening effect to any standard drumstick in a retrofittable fashion. The drumstick can be any shape or size, but for purposes of describing the invention, a standard style drumstick is shown. It should be appreciated that the invention herein disclosed finds application in other striking devices, such as a hammer.

FIG. 2 is a cross section, perspective view of an end portion of a drumstick showing a dampening band according to the invention. In FIG. 2 the drumstick 10 provides an annular groove 21 that is adapted to receive and retain the dampening band 20 securely in place. Preferably, the depth of the annular groove is sufficient to secure the dampening band so that the outer surface of the band is flush with that of the drumstick. In this way, the dampening band is not noticeable when the drumstick is in use, although it nonetheless functions to dampen excessive vibration.

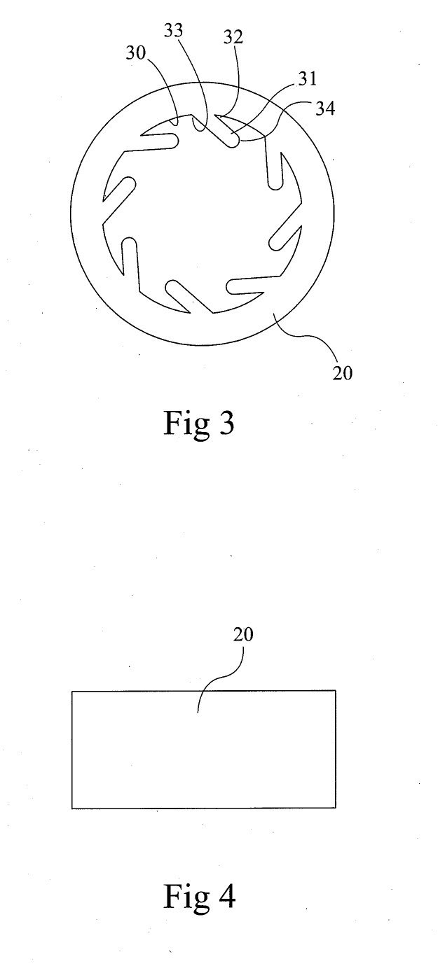

FIG. 3 is a plan view of a dampening band for a drumstick according to the invention. In FIG. 3, the band 20 is shown having an inner surface 30 about which a plurality of resilient, flexible ribs 31 are arrayed. FIG. 3 shows eight such ribs, although the actual number of ribs provided is a matter of choice. Each rib has a rounded end portion 34, although it is not necessary that the end portion of the rib be rounded. However, such roundness is thought to promote dampening by reducing friction at an interface between the band and the drumstick surface.

The ribs are canted, such that one side of the rib has an acute angle relative to the inner surface of the band, while the other side of the rib has an obtuse angle relative to the inner surface of the rib. The actual angles used may be chosen as desired. For example, the acute angle may be 30 degrees and the obtuse angle may be 150 degrees. It is thought that the canting of the ribs relative to the inner surface of the band causes the ribs to act as dampening levers, where the moment of the lever imparts a dampening effect. The mass of the band itself is such that dampening occurs. Thus, the band may be made of a dense material. In the embodiment shown in FIG. 3, the band has an outer diameter of 0.56 inches, a thickness of 0.0675 inches, and a width of 0.245 inches. These measurements are exemplary and not limiting.

FIG. 4 is a side view of a dampening band 20 for a drumstick according to the invention. If desired, the surface of the band may be textured or colored, for example, to make it easy to identify the drumstick size or style.

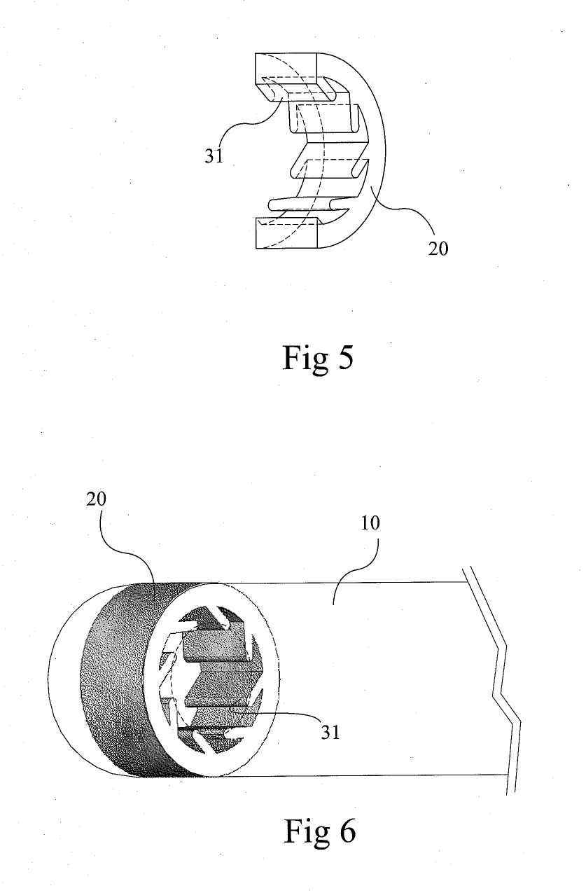

FIG. 5 is a cross section, perspective view of a dampening band 20 for a drumstick according to the invention. FIG. 5 provides a view of the ribs 31 in full detail.

FIG. 6 is a cutaway perspective view of a dampening band 20 for a drumstick 10 according to the invention.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus for dampening vibration in a drumstick, comprising:
a resilient, flexible ring that is adapted to fit into a corresponding annular groove formed near a butt end of a drumstick;
said ring having an inner surface from which a plurality of ribs project, wherein said ribs comprise a secure contact area to said drumstick that provide a tight fit of said ring thereto, while allowing said ring to move freely to dampen impact when said drumstick is struck against a surface.

2. The apparatus of claim 1, each of said ribs comprising:
a finger like protrusion on said inside surface of said ring.

3. The apparatus of claim 1, wherein each of said ribs is angled to allow a flexing that keeps a constant but not rigid contact between said ring and said drumstick.

4. The apparatus of claim 1, said ring comprising:
any of a plurality of different colors and/or textures to identify different sizes and types of drumsticks.

5. The apparatus of claim 1, said ring is made of a flexible, resilient material comprising any of an elastomer or plastic material.

6. The apparatus of claim 1, said band having an outer diameter of about 0.56 inches.

7. The apparatus of claim 1, said band having a thickness of about 0.067 inches.

8. The apparatus of claim 1, said band having a width of about 0.24 inches.

9. The apparatus of claim 1, wherein said annular groove is about 0.25 inches wide and 0.0625 thick.

10. An apparatus for dampening vibration in a drumstick, comprising:
a resilient, flexible ring that is adapted to fit onto a drumstick near a butt end thereof;
said ring having an inner surface from which a plurality of ribs project, wherein said ribs comprise a secure contact area to said drumstick that provide a tight fit of said ring thereto, while allowing said ring to move freely to dampen impact when said drumstick is struck against a surface.

11. The apparatus of claim 10, each of said ribs comprising:
a finger like protrusion on said inside surface of said ring.

12. The apparatus of claim 10, wherein each of said ribs is angled to allow a flexing that keeps a constant but not rigid contact between said ring and said drumstick.

13. The apparatus of claim 10, said ring comprising:
any of a plurality of different colors and/or textures to identify different sizes and types of drumsticks.

14. The apparatus of claim 10, said ring is made of a flexible, resilient material comprising any of an elastomer or plastic material.
